(19) United States
(12) Patent Application Publication
(10) Pub. No.: US 2006/0055118 A1
(43) Pub. Date: Mar. 16, 2006

(54) Sealing arrangement

(75) Inventor: Stefan Beichl, Herrsching (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MTU Aero Engines GmbH, Munich (DE)

(21) Appl. No.: 10/540,203

(22) PCT Filed: Nov. 26, 2003
(86) PCT No.: PCT/DE03/03918

§ 371 Date: Aug. 17, 2005

(30) Foreign Application Priority Data
Dec. 18, 2002 (DE) 102 59 381.7

(51) Int. Cl. F16J 15/44

(52) U.S. Cl. 277/346

(57) ABSTRACT

The invention relates to a sealing arrangement. The inventive sealing arrangement serves to seal rotational-symmetric parts. To this end, at least one first sealing device (20), which is provided in the form of a ring seal, is placed between the rotational-symmetric parts. According to the invention, a second sealing device (21), which is provided in the form of a brush seal, is also placed between the rotational-symmetric parts.

The present invention relates to a sealing arrangement according to the definition of the species in claim 1.

The present invention relates to a seal between two fixed, axially symmetrical components. A seal between two fixed components is also described as a static seal.

Although the present invention is described in the following based on the example of a guide vane and a gas turbine housing or support structure, it is not intended for it to be limited to this specific application. Rather, the present invention is applicable wherever fixed, axially symmetrical components are to be sealed from one another by a static sealing arrangement. Thus, the field of application of the present invention is not limited to gas turbines or other aeronautic propulsion systems.

Gas turbines, which are used in airplanes as propulsion units, for example, typically include a plurality of fixed guide vanes, disposed one behind the other in the axial direction of the gas turbine. Each of the fixed guide vanes is made up of a plurality of vane segments, the vane segments being arranged with radial clearance about a fixed housing or a fixed support structure of the gas turbine. The housing, i.e., the support structure, and the guide vane are fixed, axially symmetrical components which are disposed concentrically about one another.

In the context of a gas turbine, to prevent a flow between the fixed guide vane and the fixed housing, the related art provides for an annular seal to be placed between the vane segments of the guide vane and the housing. The annular seal seals a gap formed by the radial clearance between the vane segments and the housing. The disadvantage associated with annular seals of this kind is that they are not able to compensate for non-uniformities in the radial clearance and thus in the gap between the vane segments and the housing, respectively support structure.

Thus, the individual vane segments of a guide vane may be designed to vary in length or be disposed with a radial offset around the housing. Moreover, manufacturing tolerances of the components to be sealed from one another may result in non-uniformities in the radial gap and thus in the gap to be sealed. During operation of a gas turbine, the individual vane segments of a guide vane may expand to varying degrees in response to heating, and their curvature may flatten. In addition, the vane segments may be canted during operation of the gas turbine. All of these factors may also occur in combination with one another and result in deviations in the gap to be sealed on the order of 1 to 2 millimeters. It may be that a sealing action provided by annular seals already affords a high degree of imperviousness, however, it is not able to compensate for these kinds of non-uniformities between the components to be sealed from one another, so that it permits undesirable leakage.

Against this background, the object of the present invention is to devise an improved sealing arrangement.

This objective is achieved in that the sealing arrangement mentioned at the outset is further refined by the features set forth in the characterizing portion of claim 1.

Due to the fact that, in addition to the at least one first sealing device designed as an annular seal, a second sealing device designed as a brush seal is arranged between the axially symmetrical components, non-uniformities in the radial gap between the axially symmetrical components to be sealed from one another are able to be compensated, thereby preventing leakage. The advantages of annular seals and brush seals are combined.

In accordance with one advantageous embodiment of the present invention, the brush seals include a plurality of bristle elements, the bristle elements being preloaded with an orientation that deviates from the radial toward the circumferential direction by, for example, 30° to 60°. In addition, the bristle elements may be preloaded in the axial direction, for example by 3° to 10°, in particular 6°, and, in some instances, may engage on the first sealing device. This produces an effective sealing action. Leakage is reduced to an absolute minimum.

Preferably, the second sealing device having a brush seal design is positioned so as to be axially offset from the first sealing device having an annular seal design, the brush seal being directly contiguous to the annular seal, and the annular seal forming a supporting plate for the brush seal. On the one hand, this makes possible a simple and compact design of the sealing arrangement according to the present invention and, on the other hand, an especially effective sealing action.

Preferred embodiments of the present invention are derived from the dependent claims and from the following description.

An exemplary embodiment of the present invention is clarified in greater detail with reference to the drawing, without being limited thereto. In the drawing:

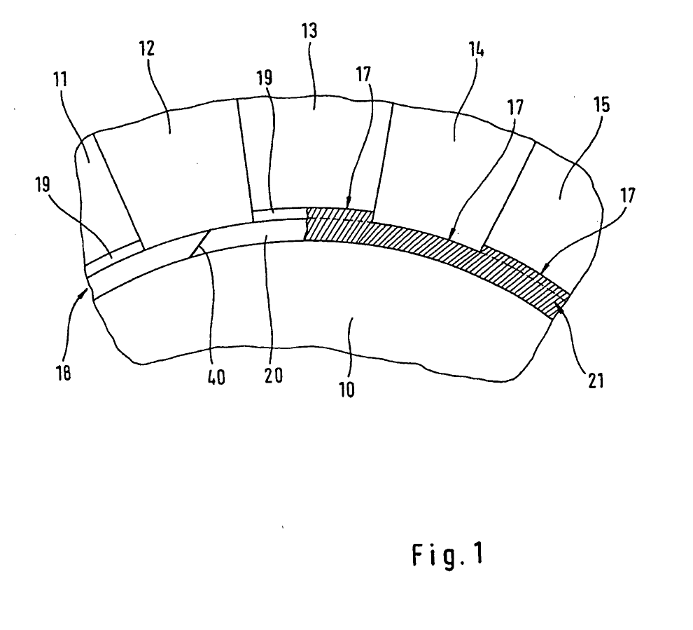

FIG. 1 shows a sealing arrangement according to the present invention in a very schematized front view;

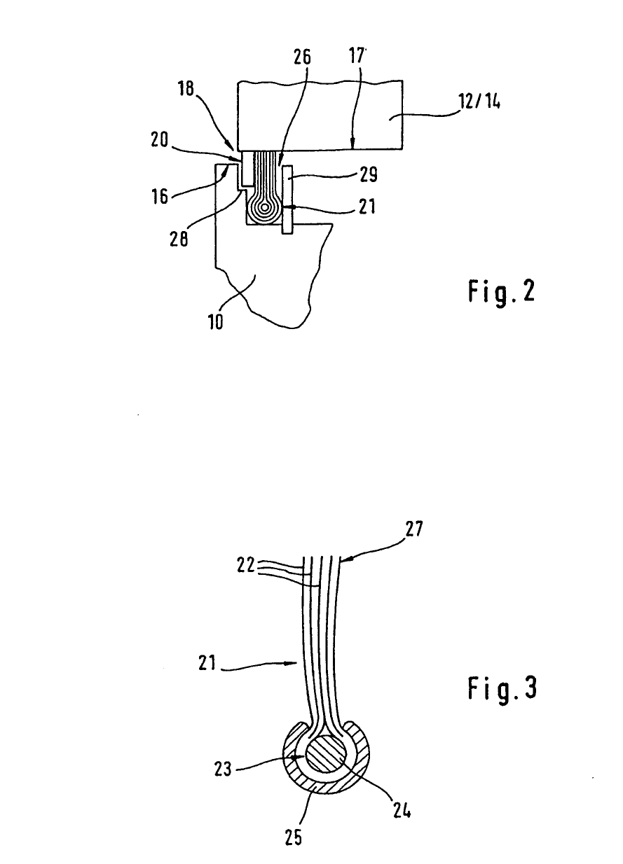

FIG. 2 illustrates the sealing arrangement according to the present invention, in accordance with FIG. 1 in a very schematized cross section;

FIG. 3 is a detail of a brush seal of the sealing arrangement according to the present invention, in accordance with FIGS. 1 and 2;

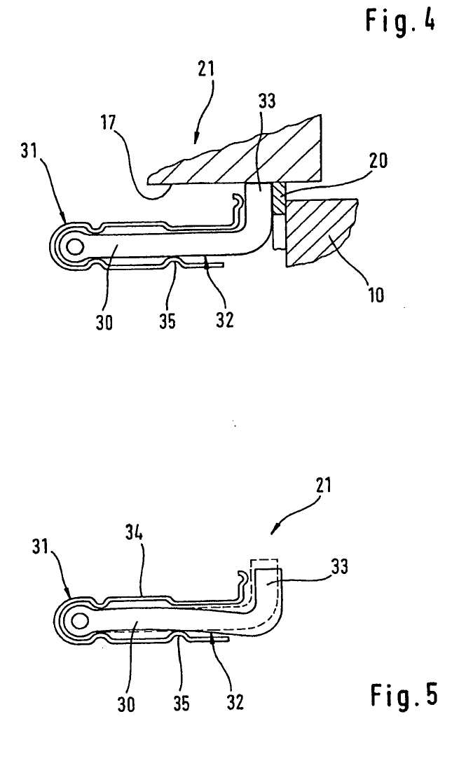

FIG. 4 is a detail of an alternative brush seal for a sealing arrangement according to the present invention; and

FIG. 5 shows the alternative brush seal in accordance with FIG. 4, in a state of compressive strain.

FIG. 1 shows a highly schematized detail of a housing 10 of a gas turbine along with altogether five vane segments 11, 12, 13, 14 and 15 of a guide vane arranged around housing 10. Both housing 10—which may be designed as a hub-centered, free-standing support structure—, as well as the guide vane including vane segments 11, 12, 13, 14 and 15 have a fixed design as axially symmetrical components. The axially symmetrical guide vane is disposed concentrically about axially symmetrical housing 10.

As may be inferred in particular from FIG. 2, which shows the arrangement according to FIG. 1 in a sectional view rotated by 90° relative to FIG. 1, housing 10 and vane segments 11, 12, 13, 14 and 15 are arranged with radial clearance from one another, i.e., a gap 18 is formed between an outer edge 16 of housing 10 and an inner edge 17 of vane segments 11, 12, 13, 14 and 15.

In this context, in accordance with FIG. 1, individual vane segments 11, 12, 13, 14 and 15 may be radially offset from one another, so that, for some of vane segments 11, 13 and 15, the distance between their inner edges 17 and outer edge 16 of housing 10 is greater than for other vane segments 12 and 14. Accordingly, in the area of vane segments 11, 13 and 15, gap 18 is designed to be larger than in the area of vane segments 12 and 14, as is pictured in FIG. 1 by an intermediate space 19 in the area of vane segments 11, 13 and 15. For that reason, gap 18 may have an uneven width, which may also be caused by varying degrees of expansion or inclination of vane segments 11, 12, 13, 14 and 15 during the operation of the gas turbine.

To seal gap 18 and intermediate spaces 19 between outer edge 16 of housing 10 and inner edges 17 of vane segments 11, 12, 13, 14 and 15, the present invention provides for a sealing arrangement having two sealing devices.

A first sealing device 20, which is situated between housing 10 and vane segments 11, 12, 13, 14 and 15, is designed as an annular seal. The annular seal is manufactured as a metallic piston-ring seal. Alternatively, the piston-ring seal may also be made of plastic, ceramic or of other suitable materials.

Axially offset from this annular seal, a second sealing device 21 is directly contiguous to first sealing device 20, second sealing device 21 having a brush seal design.

With the aid of first sealing device 20 designed as an annular seal, a sealing action entailing minimal leakage is only able to be ensured between housing 10 and vane segments 11, 12, 13, 14 and 15 when there are no non-uniformities in gap 18 between housing 10 and the individual vane segments 11, 12, 13, 14 and 15, thus, when gap 18 exhibits virtually the same continuous width. However, if there is a radial offset among individual vane segments 11, 12, 13, 14 and 15, or if housing 10 is not completely circular in form, then the width of gap 18 is not constant throughout. This would compromise the seal tightness of the annular seal, thereby permitting leakage. For such a case, second sealing device 21 is of particular importance. Namely, because of its design, second sealing device 21 is able to compensate for tolerances of this kind. This is shown in a highly schematized form in the right portion of FIG. 1.

FIG. 3 shows an enlarged detail of second sealing device 21. Thus, second sealing device 21 designed as a brush seal includes a plurality of brush elements 22. In the area of a fixing point 23, brush elements 22 are wound around a guide element 24 having a cored wire-type design. In addition, bristle elements 22 are secured to guide element 24 by a clamping element 25. In cross section, clamping element 25 has the shape of an open ring and has a so-called C tube design. Bristle elements 22 may also be secured using other methods, such as fusing or adhesive bonding.

In accordance with FIG. 2, fixing point 23 is positioned in a recess 26 of housing 10. Bristle elements 22 of second sealing device 21 engage by their unattached ends on inner edges 17 of vane segments 11, 12, 13, 14, 15, and, in fact, regardless of whether or not there is a radial offset among vane segments 11, 12, 13, 14 and 15. In this connection, it is significant that bristle elements 22 are radially preloaded in the circumferential direction. Thus, it is possible in this manner to achieve a defined engagement of ends 27 of bristle elements 22 against inner edges 17 of vane segments 11, 12, 13, 14 and 15. If the width of gap 18 is enlarged, then the preloading of bristle elements 22 is to a lesser degree. On the other hand, if the width of gap 18 is reduced in size, then bristle elements 22 are preloaded to a greater degree. In addition, bristle elements 22 may be preloaded away from the radial toward the axial direction and engage on first sealing device 20 to achieve an improved sealing action.

As may be inferred from FIG. 2 in particular, first sealing device 20 having an annular seal design forms a supporting plate for bristle elements 22 of second sealing device 21 having a brush seal design. Bristle elements 22 rest in sections against the annular seal and are thereby stabilized in their position.

Recess 26 in housing 10 for receiving fixing point 23 of the brush seal is likewise used for receiving the annular seal. In one region facing the annular seal, recess 26 is provided with a shoulder 28, at one end, the annular seal adjoining shoulder 28. The annular seal rests with one opposite end in the area of vane segments 12 and 14 against the same, thereby sealing gap 18. On the other hand, with regard to radially offset vane segments 11, 13 and 15, the annular seal does not rest against the same, but rather leaves open a partial gap defined by intermediate spaces 19. However, this is sealed by the brush seal (see FIG. 1).

First sealing device 20 having an annular seal design and second sealing device 21 having a brush seal design are axially symmetrical, as are housing 10 and the guide vanes, and are positioned between these two concentrically disposed, axially symmetrical components.

In the case that brush seal 21 is of a closed-type design, it is inserted into recess 26 of housing 10 in the axial direction and secured in this position by a fastening ring 29. Oppositely facing shoulder 28, recess 26 is bounded by fastening ring 29, which, in the illustrated exemplary embodiment, is designed as a separate element.

However, it is likewise possible that fastening ring 29 is an integral component of housing 10. In such a case, brush seal 21 then has an open-type design. In this specific embodiment, the brush seal may be bent upwards in the manner of a split ring and be inserted or snapped in over fastening ring 29 into recess 26 of housing 10.

In place of brush seal shown in FIGS. 2 and 3, the hook-type brush seal shown in FIGS. 4 and 5 may be used as a second sealing device 21. The hook-type brush seal is a special type of brush seal having bristle elements 30 which are angled by approximately 90°.

Such a hook-type brush seal is then secured by fixing point 31 in a recess (not shown) of housing 10, a first section 32 of bristle elements 30 extending in the axial direction of housing 10. By a second section 33 of bristle elements 30, which is angled by about 90° from first section 32 of bristle elements 30, bristle elements 30 then rest against inner edge 17 of vane segments 11, 12, 13, 14 and 15 and against first sealing device 20. At least first section 32 of bristle elements 30 extending in the axial direction of housing 10 may be surrounded by a cladding 34, cladding 34 having a middle notch 35. To compensate for non-uniformities in gap 18 to be sealed, bristle elements 30 may be deformed along notch 35, so that they are shifted from the position illustrated by a dotted line in FIG. 5 to the one illustrated by a solid line in the same figure. Therefore, this occurs when the width of the gap to be sealed is made narrower. The use of such a hook-type brush seal makes it possible for the design to be further compressed.

In FIG. 1, first sealing device 20, designed as a piston-ring seal, has a separation site 40, which enables its diameter to be flexibly adapted to a limited degree. Separation site 40 may have any desired design, such as an overlapping form. In the case of two first sealing devices 20, separation sites 40 should be circumferentially offset from each other by 180°. The sealing action is also improved by second sealing device 21 with respect to any potential leakage in the area of separation site 40.

Along the lines of the present invention, a static seal for gas turbines is devised that is particularly effective and simple in terms of design. Leakage does not result from any displacement among individual vane segments of the guide vane of a gas turbine during operation of the gas turbine, or due to any potential out-of-roundness of the housing. A high degree of imperviousness may be ensured in all situations. The bristle elements of the brush seal compensate for displacement of the segments and for out-of-roundness. The advantages of brush seals and of annular seals or piston-ring seals are combined.

The sealing arrangement according to the present invention is not limited in its application to gas turbines. Rather, the present invention may be used wherever there is a need for fixed, axially symmetrical components to be sealed from one another by a static sealing arrangement.

1-19. (canceled)

20. A sealing arrangement, comprising:
at least one first sealing device including an annular seal;
a second sealing device including a brush seal;
wherein the first and second sealing devices are placed between axially symmetrical components, and the second sealing device is positioned so as to be axially offset from the first sealing device; and
wherein the annular seal is a metallic piston-ring seal having a separation site.

21. The sealing arrangement as recited in claim 20,
wherein the brush seal is a closed-type brush seal.

22. The sealing arrangement as recited in claim 20,
wherein the brush seal has an open-type brush seal.

23. The sealing arrangement as recited in claim 22,
wherein the open-type brush seal is in the form of a split ring.

24. The sealing arrangement as recited claim 20,
wherein the brush seal is a hook-type brush seal.

25. The sealing arrangement as recited in claim 20,
wherein the brush seal includes a plurality of bristle elements.

26. The sealing arrangement as recited in claim 24,
wherein the bristle elements are wound around a guide element, forming a fixing point, and are secured by a clamping element to the guide element.

27. The sealing arrangement as recited claim 20,
wherein one end of the the second sealing device is positioned in a recess of a first one of the axially symmetrical components.

28. The sealing arrangement as recited in claim 27, wherein the bristle elements are wound around a guide element, forming a fixing point, and wherein the brush seal is situated in the recess in such a way that the fixing point is positioned in the recess of the first one of the axially symmetrical components, and the unattached ends of the bristle elements extend toward a second one of the axially symmetrical components.

29. The sealing arrangement as recited in claim 28, wherein the unattached ends of the bristle elements engage the second one of the axially symmetrical components.

30. The sealing arrangement as recited claim 25, wherein the bristle elements are radially preloaded such that they have a curved shape in the radial direction.

31. The sealing arrangement as recited in claim 20,
wherein, in the axial direction of the axially symmetrical components, the second sealing device is directly contiguous to the first sealing device.

32. The sealing arrangement as recited in claim 25,
wherein the first sealing device forms a supporting plate for the bristle elements of the second sealing device.

33. The sealing arrangement as recited in claim 20,
wherein a second one of the axially symmetrical components surrounds a first one of the axially symmetrical components.

34. The sealing arrangement as recited in claim 33, wherein the second one of the axially symmetrical components is made up of a plurality of segments.

35. The sealing arrangement as recited in claim 20,
wherein a first one of the axially symmetrical components comprises a housing of a gas turbine, and the second one of the axially symmetrical component includes a guide vane ring of the gas turbine having a plurality of vane segments, the first sealing device and the second sealing device being positioned between the housing and the vane segments in order to seal a gap.
